(19) United States
(12) Patent Application Publication
(10) Pub. No.: US 2024/0298369 A1
(43) Pub. Date: Sep. 5, 2024

(54) RADIO RECONFIGURATION IN MULTI-LINK DEVICE

(71) Applicant: Samsung Electronics Co., Ltd., Suwon-s (KR)

(72) Inventors: Vishnu Vardhan Ratnam, Plano, TX (US); Boon Loong Ng, Plano, TX (US); Rubayet Shafin, Allen, TX (US); Peshal Nayak, Plano, TX (US); Yue Qi, Plano, TX (US); Elliot Yuchih Jen, Taipei City (TW)

(21) Appl. No.: 18/419,363

(22) Filed: Jan. 22, 2024

Related U.S. Application Data
(60) Provisional application No. 63/449,481, filed on Mar. 2, 2023.

(51) Int. Cl. H04W 76/15; H04L 1/00; H04W 74/0816

(52) U.S. Cl. CPC H04W 76/15; H04L 1/0003; H04W 74/0816

(57) ABSTRACT

A wireless communication network includes a non-access point (AP) multi-link device (MLD) and an AP MLD. The non-AP MLD comprises at least two stations (STAs) affiliated with the non-AP MLD and a processor coupled to the at least two STAs. The processor is configured to communicate with the AP MLD on a plurality of links established between the non-AP MLD and the AP MLD. The processor is configured to generate a notification indicating a change in a set of numbers of supported spatial streams for each of one or more links established between the non-AP MLD and the AP MLD. The processor is configured to transmit a frame including the notification to the AP MLD. The processor is configured to initiate radio reconfiguration on the one or more links using the change in the set of numbers of supported spatial streams for each of the one or more links.

### CROSS-REFERENCE TO RELATED APPLICATIONS

This application claims the benefit of priority from U.S. Provisional Application No. 63/449,481, entitled “METHOD AND APPARATUS FOR UPDATING MCS AND NSS SET OF RECONFIGURABLE MLMR DEVICES,” filed Mar. 2, 2023, which is incorporated herein by reference in its entirety.

### TECHNICAL FIELD

This disclosure relates generally to a wireless communication system, and more particularly to, for example, but not limited to, a multi-link device in a wireless communication system.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a non-AP MLD associated with an AP MLD in a wireless network. The non-AP MLD comprises at least two stations (STAs), each STA being affiliated with the non-AP MLD and a processor coupled to the at least two STAs. The processor is configured to communicate with the AP MLD on a plurality of links established between the non-AP MLD and the AP MLD. The processor is configured to generate a notification indicating a change in a set of numbers of supported spatial streams for each of one or more links established between the non-AP MLD and the AP MLD. The processor is configured to transmit a frame including the notification to the AP MLD. The processor is configured to initiate radio reconfiguration on the one or more links using the change in the set of numbers of supported spatial streams for each of the one or more links.

In some embodiments, the set of numbers of supported spatial streams includes a set of numbers of supported spatial streams for one or more modulation and coding schemes for each of the one or more links.

In some embodiments, the processor is configured to receive a response frame in response to the notification from the AP MLD, and to initiate the radio reconfiguration on the one or more links using the change in the set of numbers of supported spatial streams for each of the one or more links.

In some embodiments, the processor is configured to initiate the radio reconfiguration on the one or more links using the change in the set of numbers of supported spatial streams for each of the one or more links after a predetermined time following the transmission of the frame.

In some embodiments, the notification includes a first field indicating the one or more links and one or more second fields, each second field indicating a change in a number of supported spatial streams for a respective link indicated in the first field.

In some embodiments, the notification includes a third field indicating when the changed number of supported spatial streams is applicable on the respective link.

In some embodiments, the notification indicates a decrease in a number of supported spatial streams for a first link established between a first STA affiliated with the non-AP MLD and a first AP affiliated with the AP MLD.

In some embodiments, the processor is further configured to transmit, to the AP MLD, another frame includes a notification indicating an increase in a number of supported spatial streams for a second link established between a second STA affiliated with the non-AP MLD and a second AP affiliated with the AP MLD after the radio reconfiguration is completed.

In some embodiments, the processor is further configured to transition the first STA to a doze state when the change number of supported spatial streams for the first STA is zero.

One aspect of the present disclosure provides an AP MLD in a wireless network. The AP MLD comprises at least two APs, each AP being affiliated with the AP MLD, and a processor coupled to the at least two APs. The processor is configured to communicate with one or more non-AP MLDs on a plurality of links established between the AP MLD and the one or more non-AP MLDs. The processor is configured to generate a notification indicating a change in a set of numbers of supported spatial streams for each of one or more links established between the AP MLD and the one or more non-AP MLDs. The processor is configured to transmit a frame including the notification to the one or more non-AP MLDs. The processor is configured to initiate radio reconfiguration on the one or more links using the change in the set of numbers of supported spatial streams for each of the one or more links.

In some embodiments, the set of numbers of supported spatial streams includes a set of numbers of supported spatial streams for one or more modulation and coding schemes for each of the one or more links.

In some embodiments, the notification includes a timer information indicating when the radio configuration is initiated.

In some embodiments, the processor is configured to initiate the radio reconfiguration on the one or more links using the change in the set of numbers of supported spatial streams for each of the one or more links after a predetermined time following the transmission of the frame.

In some embodiments, the frame is a broadcast frame or an individually addressed frame.

In some embodiments, the notification includes a first field indicating the one or more links and one or more second fields, each second field indicating a change in a number of supported spatial streams for a respective link indicated in the first field.

In some embodiments, the notification indicates a decrease in a number of supported spatial streams for a first link established between a first AP affiliated with the AP MLD and one or more first STAs affiliated with the one or more non-AP MLDs.

In some embodiments, the processor is further configured to transmit, to the AP MLD, another frame includes a notification indicating an increase in a number of supported spatial streams for a second link established between a second AP affiliated with the AP MLD and one or more second STAs affiliated with the one or more non-AP MLDs after the radio reconfiguration is completed.

In some embodiments, the processor is further configured to coordinate that the first AP transmits a quite element for a duration to the one or more first STAs when the change number of supported spatial streams for the first AP is zero.

In some embodiments, the processor is further configured to coordinate that the first AP transmits a clear to send (CTS) frame when the change number of supported spatial streams for the first AP is zero, wherein a receiver address in the CTS frame is equal to an address of the first AP.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example capabilities element in accordance with an embodiment.

FIG. 5A shows an example Operating Mode Notification element in accordance with an embodiment.

FIG. 5B shows an example Operating Mode A-control field in accordance with an embodiment.

FIG. 6 shows an example scenario where reconfiguration is applicable in accordance with an embodiment.

FIG. 7 shows an example reconfigurable MLD in accordance with an embodiment.

FIG. 8 shows an example reconfiguration process in accordance with an embodiment.

FIG. 9 shows an example determination of RX NSS supported in current configuration in accordance with an embodiment.

FIG. 10 shows an example reconfiguration process in accordance with an embodiment.

FIG. 11 shows an example element for updating RX NSS and TX NSTS for affiliated STAs in accordance with an embodiment.

FIG. 12 shows an example EML control field in accordance with an embodiment.

FIG. 13 shows an example protected EML OMN frame action field format in accordance with an embodiment.

FIG. 14 shows an example EML control field in accordance with an embodiment.

FIG. 15 shows an example ML reconfiguration element in accordance with an embodiment.

FIG. 16 shows a flow chart of an example process for reconfiguration performed by a non-AP MLD in accordance with an embodiment.

FIG. 17 shows a flow chart of an example process for reconfiguration performed by a non-AP MLD in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the

Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IOT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

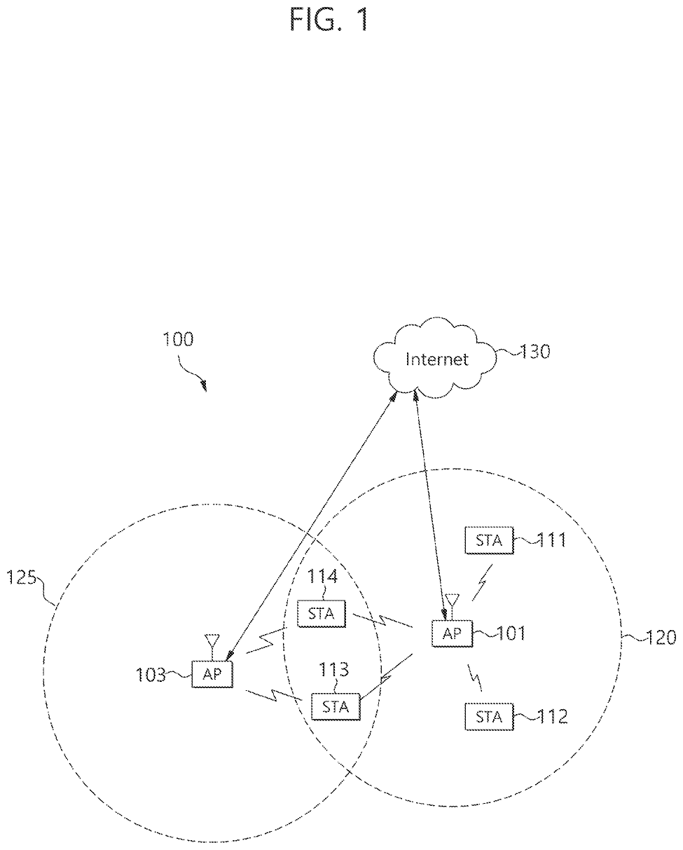

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

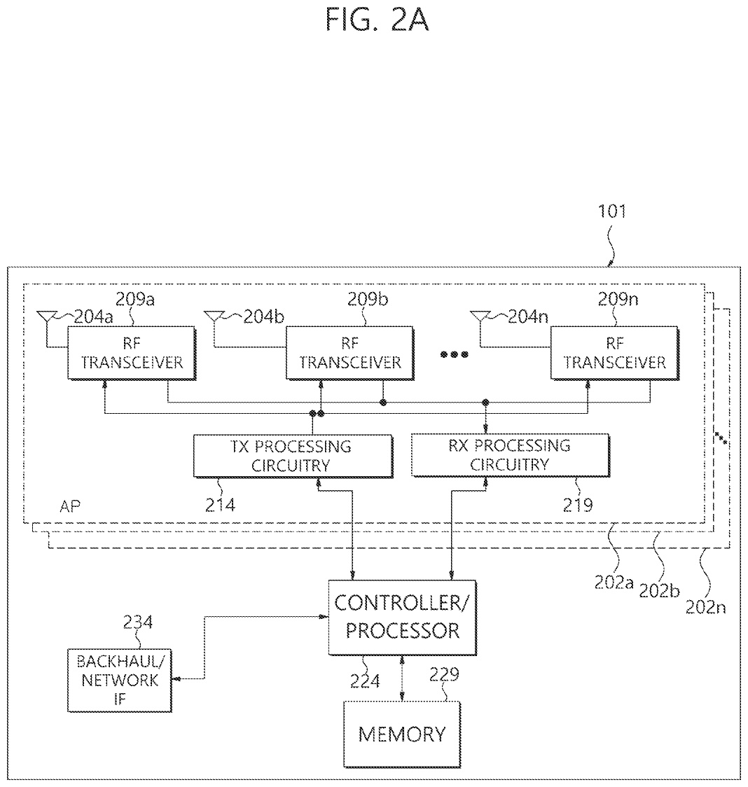

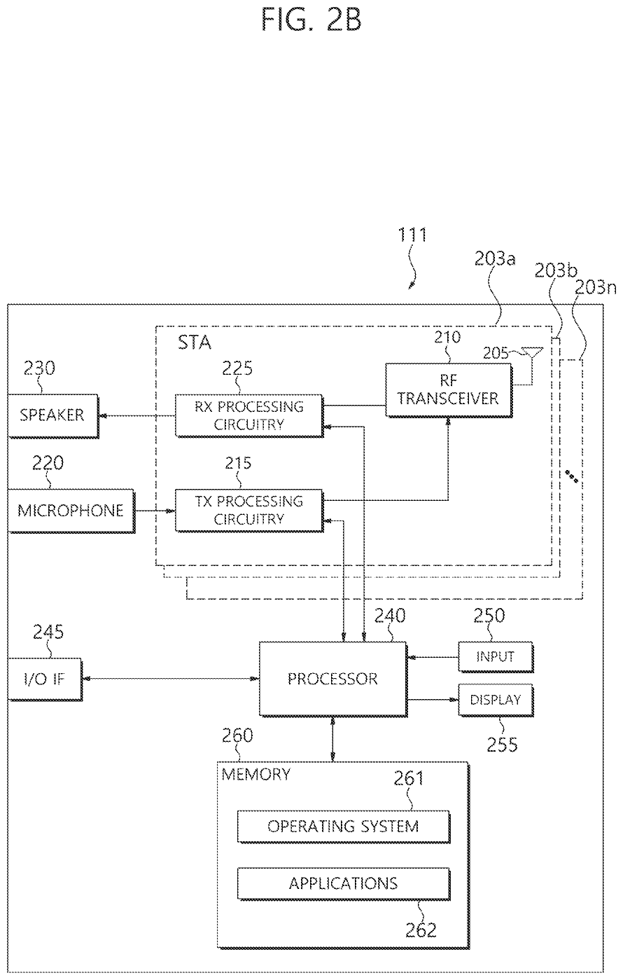

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

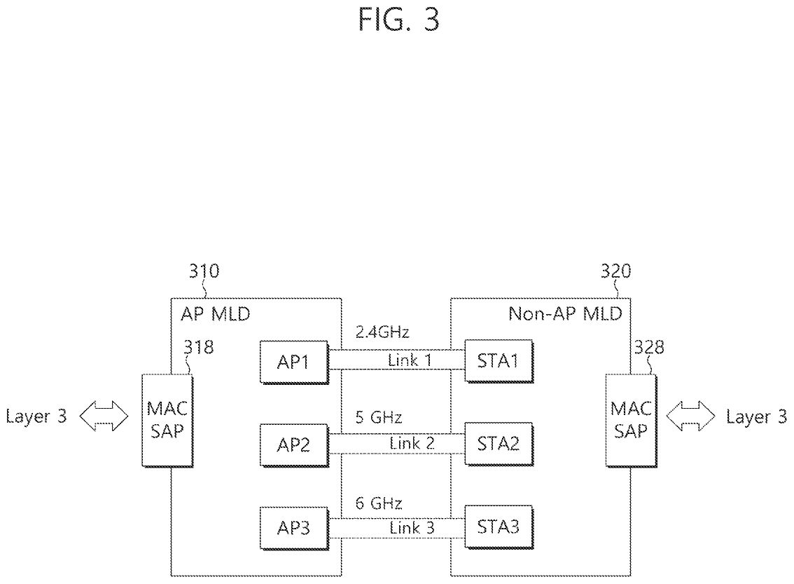

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

This disclosure provides various embodiments for a non-AP MLD or an AP MLD to indicate any update on the MCS and NSS that can be supported by one or more of their affiliated STAs using an individually addressed frame or a broadcast frame without the re-association process. The following documents are hereby incorporated by reference in their entirety into the present disclosure as if fully set forth herein: i) IEEE 802.11-2020, “Wireless LAN Medium Access Control (MAC) and Physical Layer (PHY) Specifications” and ii) IEEE P802.11be/D3.0, “Wireless LAN Medium Access Control (MAC) and Physical Layer (PHY) Specifications.”

Each AP affiliated with an AP MLD may indicate operating parameters and capabilities of other APs affiliated with the AP MLD using a basic multi-link (ML) element within a beacon frame or a probe response frame. In some embodiments, when performing an association with an AP MLD, a non-AP MLD may indicate operating parameters and capabilities of each link to be set up in a basic ML element in an association/reassociation request frame. A non-AP MLD may indicate establishment of links with a subset of APs affiliated with the AP MLD. An AP MLD may indicate which the links are accepted or rejected through an association/reassociation response frame.

For each link of an MLD, the MLD may indicate a set of supported maximum numbers of spatial streams (NSS) and modulation and coding schemes (MCS) for transmission (TX) and reception (RX) using capabilities elements, for example, an EHT-MCS Map subfields of the Supported EHT MCS and NSS Set field of an EHT (extremely high throughput) capabilities element.

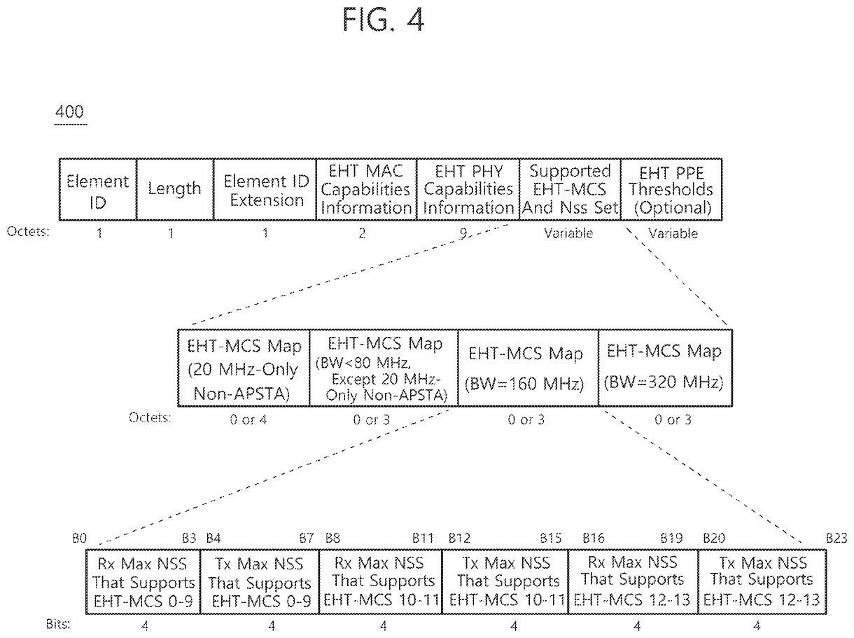

FIG. 4 shows an example capabilities element 400 in accordance with an embodiment. The example depicted in FIG. 4 is for explanatory and illustration purposes. FIG. 4 does not limit the scope of this disclosure to any particular implementation.

In FIG. 4, the capabilities element 400 includes an Element field, a Length field, an Element ID Extension field, an EHT MAC Capabilities Information field, an EHT PHY Capabilities Information field, a Supported EHT-MCS And NSS Set field, and an optional EHT PPE (PHY packet extension) Thresholds field.

The Element field and the Element ID Extension field may include information to identify the capabilities element 400. The Length field may indicate the length of the capabilities element 400.

The EHT MAC Capabilities Information field and the EHT PHY Capabilities Information field may include various information regarding MAC capabilities and PHY capabilities, respectively. Detailed examples for both fields are defined in IEEE P802.11be/D3.0 which is incorporated by this disclosure.

The EHT PPE Threshold field may determine the nominal packet padding value for a particular RU (resource unit) or MRU (multiple resource unit) allocation and particular NSS in an EHT PPDU.

The Supported EHT-MCS And NSS Set field may include the combinations of EHT-MCS 0-13 and number of spatial stream (NSS) supported by a STA for reception and transmission. As shown in FIG. 4, the Supported EHT-MCS And NSS Set field may include an EHT-MCS Map (20 MHz-only Non-AP STA) subfield, an EHT-MCS Map (BW≤80 MHz, Except 20 MHz-Only Non-AP STA) subfield, an EHT-MCS Map (BW=160 MHz), and an EHT-MCS Map (BW=320 MHz) subfield. Each subfield may indicate the maximum NSS supported for reception and transmission that the STA can transmit for each MCS value. For example, the EHT-MCS Map (BW=160 MHz) subfield, as depicted in FIG. 4, may include six (6) subfields that indicate RX or TX maximum NSSs that support EHT-MCS 0-9, 10-11, and 12-13. Table 1 provides an example encoding of the maximum NSS for specified MCS value.

TABLE 1

| | Maximum number of spatial streams that |
|---|---|
| Max NSS subfield Value | supports the specified MCS set |
| 0 | Not supported |
| 1 | 1 |
| 2 | 2 |
| 3 | 3 |
| 4 | 4 |
| 5 | 5 |
| 6 | 6 |
| 7 | 7 |
| 8 | 8 |
| 9-15 | Reserved |

The capabilities element 400 may operate as a ‘per link indication’ when transmitted by an AP MLD. The capabilities element 400 may be carried in a beacon frame or an association/reassociation response frame, or a probe response frame transmitted by the AP MLD. Similarly, the capabilities clement 400 may operate as a ‘per link indication’ when transmitted by a non-AP MLD. The capabilities element 400 may be carried in an association/reassociation request frame, a probe request frame, or a TDLS (Tunnel Direct Link Setup) discovery request/response frame transmitted by the non-AP MLD.

The ‘Supported EHT-MCS And NSS Set field’ alone may not determine the specific NSS that an MLD can transmit or receive. In some implementations, a STA may change operating mode, such as operating bandwidth and the maximum NSS that the STA can support. For example, a STA may change the RX operating mode by i) transmitting an Operating Mode (OM) Notification frame, which is an action frame (Class 3 management frame), ii) transmitting an OM Notification element within a beacon frame, a (Re)association request/response frame, or iii) transmitting an OM Control subfield or EHT OM Control subfield in an A-control field of a QoS (Quality of service) Data, QoS Null or Class 3 management frames.

A non-AP STA may change the TX operating mode by transmitting an OM control subfield or EHT OM control subfield in an A-control field of a QoS Data, QoS Null or Class 3 management frames.

For any MCS, the maximum NSS for reception that a STA can support may be determined by the smaller of the followings:
the value of the ‘Rx Max NSS That Supports Specified MCS’ subfield for the given EHT-MCS indicated in the Supported EHT-MCS And NSS Set field; or
the maximum supported NSS indicated by i) the value of the Rx NSS field of the OM notification frame or the OM notification element if the value of Rx NSS type is 0, ii) the value of the Rx NSS field of the OM control subfield if the EHT OM control subfield is not present in the same A-control field, or iii) the value of the Rx NSS Extension field of the EHT OM control subfield combined with the value of the Rx NSS field of the OM control subfield.

For any MCS, the maximum NSS for transmission that a STA can support may be determined by the smaller of the followings:
the value of the ‘Tx Max NSS That Supports Specified MCS’ field for the given EHT-MCS indicated in the Supported EHT-MCS and NSS Set field; or
the maximum supported NSS indicated by i) the value of the Tx NSTS subfield of the OM control subfield if the EHT OM control subfield is not present in the same A-control field, or ii) the value of the Tx NSTS extension subfield of the EHT OM control subfield combined with the value of the Tx NSTS field of the OM control subfield.

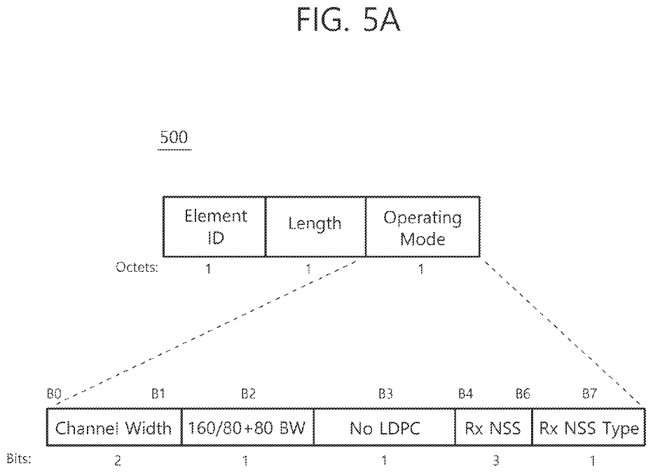

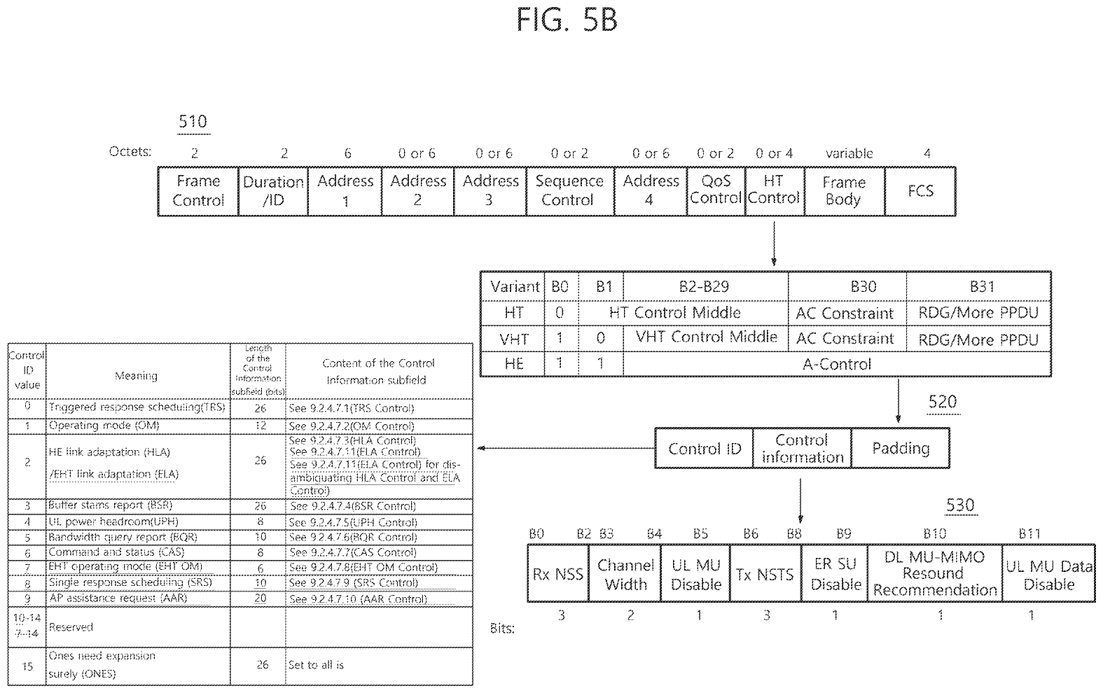

FIG. 5A shows an example Operating Mode Notification element 500 in accordance with an embodiment, and FIG. 5B shows an example Operating Mode A-control field in accordance with an embodiment.

Referring to FIG. 5A, the Operating Mode Notification element 500 includes an Element ID field, a Length field, and an Operating Mode field. The Operating Mode field includes a Channel Width subfield, a 160/80+80 BW subfield, an No LDPC subfield, an RX NSS subfield and Rx NSS Type subfield. Various fields and subfields depicted in FIGS. 5A may correspond to fields and subfields defined in IEEE P802.11be/D3.0 and IEEE 802.11-2020 which are incorporated by this disclosure.

Referring to FIG. 5B, HE (high efficiency) A-Control field 520 is included in an HT Control field of the MAC frame 510. The HE A-Control field 520 includes a Control ID subfield, a Control Information subfield, and Padding bits. FIG. 5B illustrates an example Control information subfield 530 when the Control ID subfield is set to ‘1’ to indicate the ‘Operating Mode (OM).’

During multi-link operation, the capabilities on each link may change over time. For example, an AP MLD may intend to remove some of its affiliated APs to save power when the traffic is low. To indicate such a reconfiguration in the multi-link operation, a reconfiguration multi-link (ML) element may be used.

The reconfiguration ML element may be incorporated into a beacon frame or a probe response frame to announce the removal of some APs affiliated with the AP MLD. The reconfiguration ML element may be transmitted before the affiliated APs are removed. In some implementations, an AP removal timer may be included in the reconfiguration ML element to indicate the number of TBTT (target beacon transmit times) until the affiliated AP is removed. The reconfiguration ML element may be included in a multi-link operation update request frame transmitted by a non-AP MLD to indicate a change of operation parameters. In some implementations of the reconfiguration ML element, the Operation Update Type in the Per-STA Profile subelment is defined as only one type ‘Operation Update Type=0.’ This Operation Update Type may be used to change the maximum A-MSDU (aggregate MAC protocol data unit) length and maximum MPDU (MAC protocol data unit) length that each STA of non-AP MLD can receive. The goal is to more efficiently utilize the memory of a non-AP MLD when some links are removed. One or more Per-STA profile sub-elements are included in the Link Info field. Each Per-STA profile includes a STA Control field that identifies the type of reconfiguration and presence of different parameters in STA info field.

In order to opportunistically enhance the supported MCS and NSS and improve spectral efficiency, the next WLAN system may support enhanced multi-link multi-radio (EMLMR) mode. An MLD supporting the EMLMR mode may support reception or transmission of frames on multiple links simultaneously and has the ability to move its radios across links. For example, after a non-AP MLD in the EMLMR mode initiates a frame exchange sequence with a first AP of an AP MLD on a first link, the non-AP MLD can move radios from other links to the first link to improve the supported MCS and NSS on the first link. The set of links for the non-AP MLD in the EMLMR mode with the capability to move radios from one link to other link may be referred to as ‘EMLMR links.’

In some embodiments, when both the AP MLD and non-AP MLD support EMLMR operation, a STA affiliated with the non-AP MLD may initiate the EMLMR operation by transmitting an EML Operating Mode Notification Frame (EOMNF) to the corresponding AP affiliated with the AP MLD. The ‘EMLMR mode’ bit may be set to ‘1’ in the EML control field of the EOMFR frame. The EOMNF may contain several parameters for the EMLMR operation including the identity of the links that can be considered for the EMLMR mode, for example, using an EMLMR Link bitmap field. In the EML control field of EML Operating Mode Notification Frame (EOMNF), the non-AP MLD may also include an ‘EMLMR supported MCS and NSS Set’ subfield. This subfield may indicate the maximum supported MCS and NSS for each link in the EMLMR mode using an MCS map. This information may override the values previously indicated in the ‘EHT-MCS Map’ subfield of the ‘Supported EHT MCS and NSS Set’ field of the EHT capabilities element for each link indicated in the EMLMR Link bitmap field of the EOMNF. In order to exit from the EMLMR operating mode, the non-AP MLD may transmit an EOMNF with the EMLMR mode bit of the EML control field set to ‘0’ to the AP MLD.

In the multi-link operation, the MLDs that are capable of moving radios and spatial streams across their links may be referred to as ‘reconfigurable MLMR devices’ or ‘reconfigurable MLD’ in this disclosure. Examples of the reconfigurable MLMR device may include, but are not limited to, an EMLSR device and an EMLMR device. The need or benefit for the quasi-static reconfiguration may arise in various situations, including but not limited to: i) when the bandwidth, load, or OBSS (overlapping basic service set) interference of one link becomes better than that of another link, ii) when one link (or one affiliated AP) is removed from the AP MLD, and iii) when the RSSI (receive signal strength indicator) of some links changes due to mobility, causing one of the links non-viable. When the reconfiguration occurs at the non-AP MLD or the AP MLD, the following changes may take place: i) the maximum NSS that each link can support for transmission and reception, and ii) the supported NSS at each MCS.

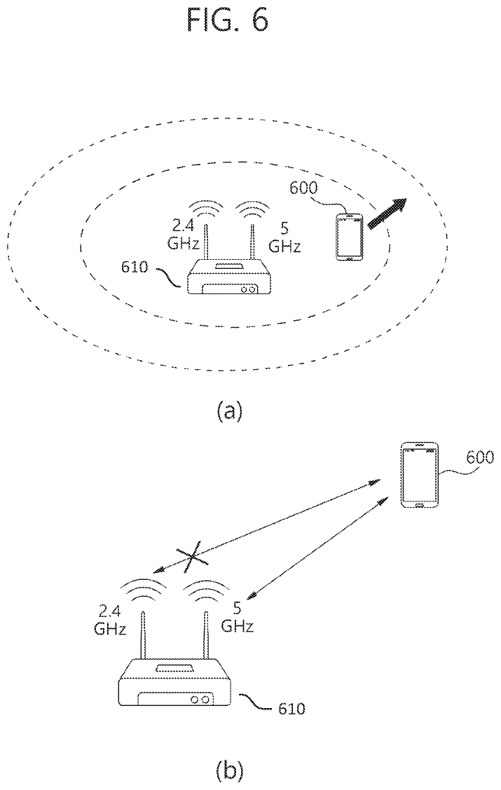

FIG. 6 shows example scenarios where the reconfiguration is applicable in accordance with an embodiment. Referring to FIG. 6 (a), a non-AP MLD 600 capable of communication on both 2.4 GHz link and 5 GHz link with an AP MLD 610 may move from inner circle zone to outer circle zone. When the non-AP MLD 600 exits the inner circle zone and remains in the outer circle zone, the non-AP MLD 600 may be unable to communicate on the 5 GHz link with the AP MLD 610 because the coverage of the 5 GHz link is smaller than that of the 2.4 GHz link. Therefore, it would be beneficial for the non-AP MLD 600 to move the radio and spatial streams used for the 5 GHz link to the 2.4 GHz link.

FIG. 6 (b) illustrates a case where one of APs affiliated with the AP MLD 610 is removed. In FIG. 6 (b), the AP MLD 610 may have two affiliated APs, each AP operating on the 2.4 GHz link and the 5 GHz link, respectively. The AP MLD 610 may remove one of its affiliated APs that operates on the 2.4 GHz link for various reasons, such as power saving. In this scenario, the AP MLD 610 may be unable to communicate on the 2.4 GHz link with the non-AP MLD 600. Therefore, it would be beneficial for the AP MLD 610 to move the radio and spatial streams used for the 2.4 GHz link to the 5 GHz link.

This reconfiguration may enhance hardware efficiency for both the AP MLD and the non-AP MLD implementations. These changes may be indicated to the AP MLD when the reconfiguration occurs at the non-AP MLD. Similarly, these changes may be broadcasted or announced by the AP MLD when the reconfiguration occurs at the AP MLD. However, in the current WLAN system, the supported MCS and NSS set and operating mode indication process are performed based on per-link indications. Furthermore, the non-AP MLD includes the supported MCS and NSS set field only in an association/reassociation request frame or a probe request frame by the non-AP MLD. As a result, indicating any operation mode changes, including reconfiguration, will require re-association, resulting in significant overheads. Therefore, there is a need for a mechanism to update the MCS and NSS sets for one or more links without the need for re-association.

This disclosure provides various embodiments for a non-AP MLD and an AP MLD to indicate any updates on the MCS and NSS that can be supported by one or more STAs or APs affiliated with the MLD using an individually addressed frame or a broadcast frame.

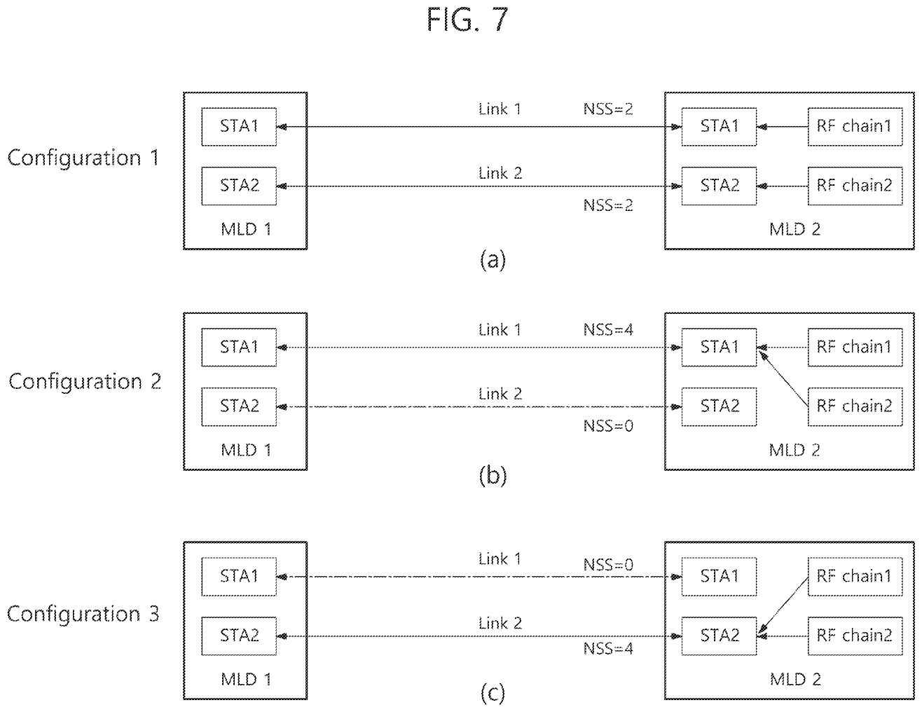

FIG. 7 shows an example reconfigurable MLD in accordance with an embodiment. The examples depicted in FIG. 7 are for illustrative purposes only and do not limit the scope of this disclosure to any particular implementation.

In FIG. 7, MLD 1 and MLD 2 are communicating with each other using multi-links, such as Link 1 and Link 2. Each of MLD 1 and MLD 2 includes two STAs (STA 1 and STA 2). The MLD 2 includes RF chain 1 and RF chain 2 which are connected to STA 1 and STA 2, respectively. FIG. 7 shows generic scenario of a reconfigurable for the MLD 2. In this example of FIG. 7, the MLDs may be MLMR MLDs, and the MLD 2 can be either an AP MLD or a non-AP MLD, while the MLD 1 can be either a non-AP MLD or an AP MLD. Additionally, STA 1 and STA 2 in FIG. 7 may be a non-AP STA or an AP STA.

Each of MLD 1 and MLD 2 can move part of its radios across its links to form various configurations, as illustrated in FIG. 7. In the example of FIG. 7 (a), after initial association, the MLD 2 is in configuration 1 and indicates the supported maximum NSS of 2 for transmission and reception as for each link (Link 1 and Link 2). In some implementations, this indication may be provided using the ‘EHT-MCS Map’ subfield of the Supported EHT MCS and NSS set field of the EHT capabilities element transmitted by the MLD 2. Alternatively, the indication may be provided by transmitting an operation mode notification frame, an operating mode notification element, or an OM control field. However, due to changes in operation conditions, such as variations in network load, signal strength, the disablement of a link, or alterations in the operating bandwidth or channel, the MLD 2 may switch from the configuration 1 to configuration 2 or configuration 3, as depicted in FIGS. 7 (b) and (c). In configuration 2, RF chain 2 is moved from Link 2 to Link 1 to support STA 1. As a result, the maximum supported NSS for transmission and reception on Link 1 becomes 4, while the maximum supported NSS for transmission and reception on Link 2 becomes zero (0). Conversely, in configuration 3, RF chain 1 is moved from Link 1 to Link 2 to support STA 2. Consequently, the maximum supported NSS for transmission and reception on Link 1 becomes zero (0), while the maximum supported NSS for transmission and reception on Link 2 becomes 4. There is a need for a mechanism to indicate changes in supported NSS for transmission/reception on each link at each MCS level in the reconfigurable MLD. Specifically, since the reconfiguration at the AP MLD needs to be indicated to all associated non-AP MLDs, both a unicast and broadcast signaling mechanism may be required.

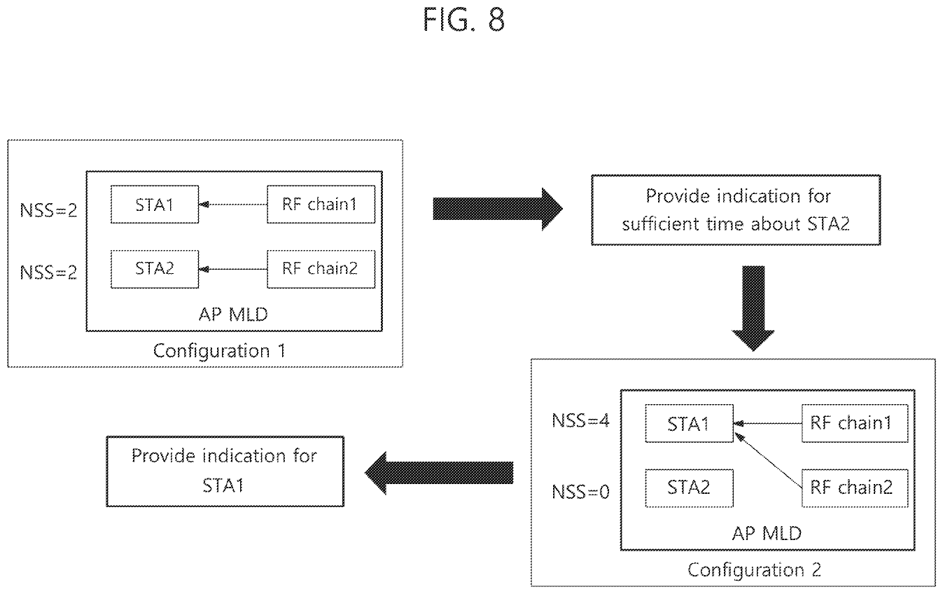

FIG. 8 shows an example reconfiguration process in accordance with an embodiment. The example depicted in FIG. 8 is also for illustrative purposes only and does not limit the scope of this disclosure to any particular implementation.

In FIG. 8, the reconfigurable MLD may be an AP MLD. Accordingly, STA 1 and STA 2 may be AP STAs in FIG. 8. When the STA 2 affiliated with AP MLD in configuration 1 intends to reduce the RX NSS, the AP MLD may include an operating mode element that indicates the reduced Max NSS value for STA 2 within a beacon frame or a probe response frame. This information may be sent to a non-AP MLD with sufficient time before the reconfiguration to ensure that even non-AP STAs in power save mode receive the indication. After this period of time, the AP MLD may switch radio for the RF chain 2 from STA 2 to STA 1, resulting in configuration 2. Following the radio switch, the AP MLD updates the MCS and NSS Map for the link on which the STA 1 operates in a basic multi-link clement within a beacon frame or a probe response frame. This change to the MCS and NSS Map may be considered as a critical update that causes an increase in the BSS parameter change count field. In some implementations, it may take a significant amount of time for a STA of the AP MLD to complete the reconfiguration. Consequently, during this period, the STA may be unable to receive frames from associated non-AP MLD, resulting in frame loss. To mitigate this issue, the STA may prevent such frame loss by either scheduling a quiet element that overlaps with the reconfiguration duration or by transmitting a CTS-to-self frame with a duration that sufficiently covers the time required to complete the reconfiguration. The CTS-to-self frame is a CTS (clear to send) frame in which the RA (receiver address) field is equal to the transmitter's MAC address.

In some embodiments, when a reconfigurable MLD performs an association, the reconfigurable MLD may report the maximum NSS for MCSs that the MLD supports across all possible configurations in a capabilities element. In some implementations, this information can be included in the ETH-MCS Map subfield of the supported EHT MCS and NSS set field of the EHT capabilities element. Table 2 below provides an example EHT-MCS Map subfield of the supported EHT MCS and NSS set field of the EHT capabilities element. The indicated NSS may be greater than what the non-AP STA supports in the current configuration used to perform the association.

TABLE 2

| RX NSS at | RX NSS at | RX NSS at | TX NSS at | TX NSS at | TX NSS at |
|---|---|---|---|---|---|
| MCS 0-9 | MCS 10-11 | MCS 12-13 | MCS 0-9 | MCS 10-11 | MCS 12-13 |
| 4 | 4 | 4 | 4 | 4 | 4 |

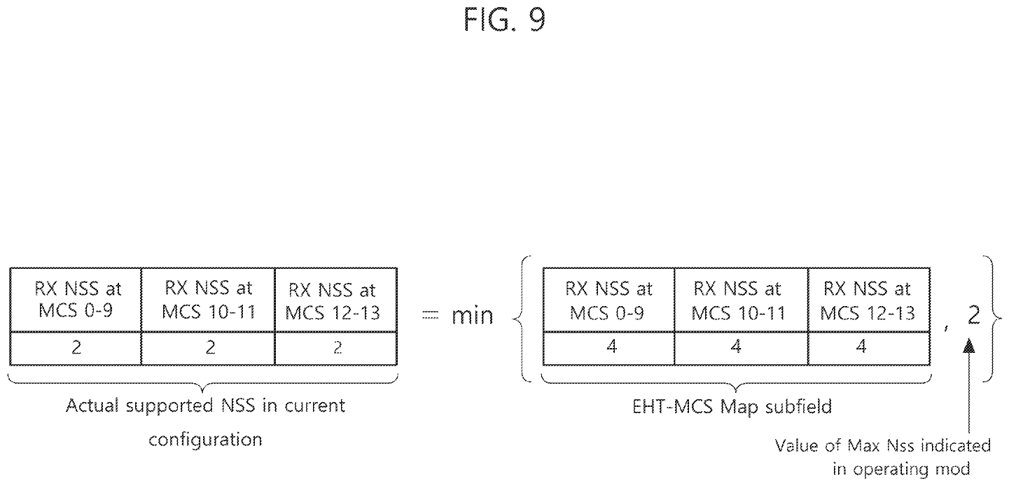

After the association process, each STA affiliated with the MLD may use the operating mode (OM) notification procedure. The notification may follow immediately after the association to prevent frame loss. In some implementations, when the MLD 2 in FIG. 7 is in configuration 1, each STA (STA 1 and STA 2) of the MLD 2 may transmit an OM notification frame or an OM control field within a frame which set the Rx NSS and Tx NSS to 2 as shown in FIG. 9.

FIG. 9 shows an example determination of RX NSS supported in current configuration in accordance with an embodiment. The example depicted in FIG. 9 is also for illustrative purposes only and does not limit the scope of this disclosure to any particular implementation.

Referring to FIG. 9, the actual RX NSS supported in a current configuration may be determined based on the smaller of the two values: i) the RX NSS indicated during the association and ii) the RX NSS value notified from the OM notification frame or the OM control field. In the example of FIG. 9, since the RX NSS value received from the OM notification frame or the OM control field is 2 and the RX NSS value indicated during the association is 4, the actual RX NSS supported in the current configuration is determined to be 2.

In some implementations, to switch from configuration 1 to configuration 2 in the example of FIG. 7, STA 1 of the MLD 2 may transmit an OM notification frame or an operating mode element, or an OM control field that set the RX NSS and/or TX NSS to 4, and STA 2 of MLD 2 may enter a doze state since the NSS of the STA 2 becomes zero (0). When the NSS value for STA 2 is zero in configuration 2, the STA 2 may use a power management by going to the doze state to prevent frame exchanges on its link or may disable the link using TID (traffic identifier)-to-link mapping procedure.

In some embodiments, when the NSS is expected to decrease on a link after reconfiguration, the operating mode notification may be provided before the reconfiguration is initiated. When the reconfigurable MLD is an AP MLD, the operating mode notification, such as the operating mode element, may be included in a beacon frame or a probe response frame transmitted from affiliated AP STA, providing sufficient time before the reconfiguration that reduces the NSS for the affiliated AP. Moreover, when the reconfigurable MLD is a non-AP MLD, it may transmit the operating mode notification, such as an OM notification frame or OM control field, indicating the reduced NSS for transmission and reception with a sufficient time before the reconfiguration. After waiting for sufficient time following the successful transmission of the operating mode notification, the MLD may switch radios to change to a new configuration.

On the other hand, when the NSS is expected to increase on a link after the reconfiguration, the operating mode notification may be provided after performing the reconfiguration.

In some embodiments, it may take some time for a STA of the MLD to complete the reconfiguration process, during which the STA may not be able to receive frames, resulting in frame loss. If the STA is affiliated with a non-AP MLD, the frame loss can be mitigated by utilizing power management, such as transitioning to a doze state. If the STA is affiliated with an AP MLD, the frame loss can be prevented by either transmitting a quiet element or transmitting a CTS-to-self frame with a duration sufficient to cover the reconfiguration time.

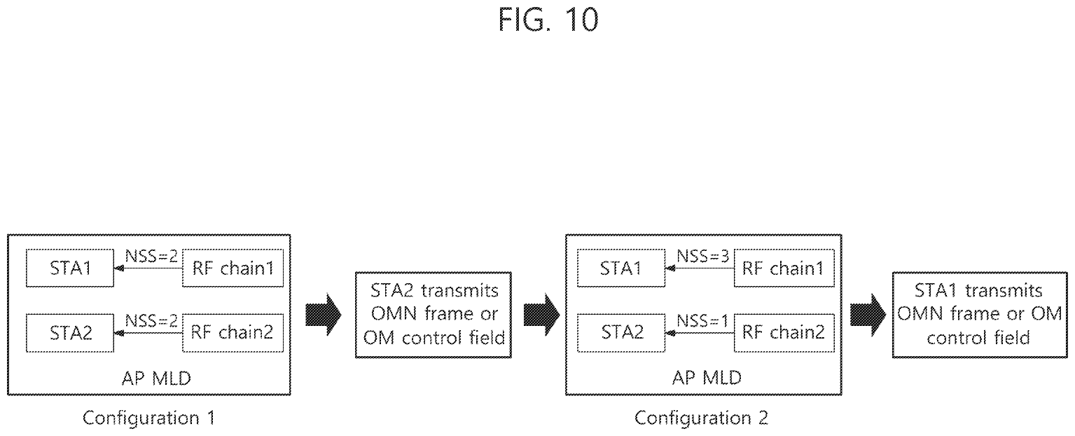

FIG. 10 shows an example reconfiguration process in accordance with an embodiment. The example depicted in FIG. 10 is for illustrative purposes only and does not limit the scope of this disclosure to any particular implementation.

Referring to FIG. 10, in the first place, the AP MLD is in configuration 1, with RX and TX NSS set to 2 for STA 1 and STA 2. It may be expected that the NSS for the STA 2 decreases. Therefore, the STA 2 of the AP MLD may transmit an OM notification frame or an OM control field, indicating the decrease of the NSS, to the corresponding STA of the non-AP MLD with sufficient time before initiating the reconfiguration. Subsequently, the AP MLD performs reconfiguration to switch from configuration 1 to configuration 2. After completing the reconfiguration, the STA 1 of the AP MLD may transmit an OM notification frame or an OMI control field, indicating the increase of the NSS, to the corresponding STA of the non-AP MLD.

In some embodiments, a new multi-link operating mode indication may be provided for a reconfigurable MLD to indicate the update maximum RX NSS and TX NSTS (number of spatial time stream) for one or more affiliated STAs. This indication may be included in a multi-link operation mode (OM) notification frame or a ML operating mode A-control field.

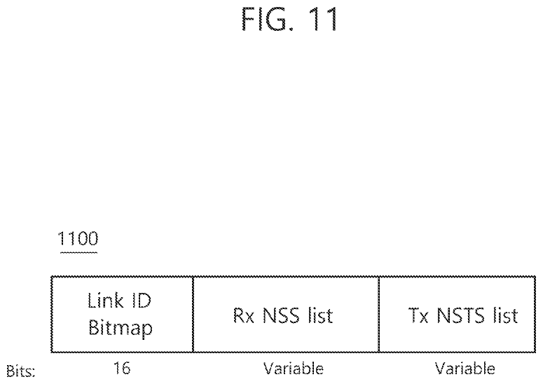

FIG. 11 shows an example element 1100 for updating RX NSS and TX NSTS for affiliated STAs in accordance with an embodiment. The example depicted in FIG. 11 is also for illustrative purposes only and does not limit the scope of this disclosure to any particular implementation.

In FIG. 11, the element 1100 may include a Link ID Bitmap field, an RX NSS list field, and a TX NSTS list field. The Link ID Bitmap field, which may be 16 bits in length, may indicate the links for which the updated maximum RX NSS and maximum TX NSTS are provided. The RX NSS list field and the TX NSTS list field may indicate a maximum RX NSS value and a maximum TX NSTS value, respectively, for the links indicated in the Link ID Bitmap field. In some implementations, when one or more bits in the Link ID Bitmap field are set to 1, the RX NSS list field and the TX NSTS list field may indicate maximum RX NSS and TX NSTS for the corresponding links in the ascending order. In some implementations, the Link ID Bitmap field may be absent, and instead, the RX NSS list field and the TX NSTS list field may be applied for all links.

In some embodiments, the reconfigurable MLD may use an EML (enhanced multi-link) operating mode notification (OMN) frame to indicate update on MCS and NSS.

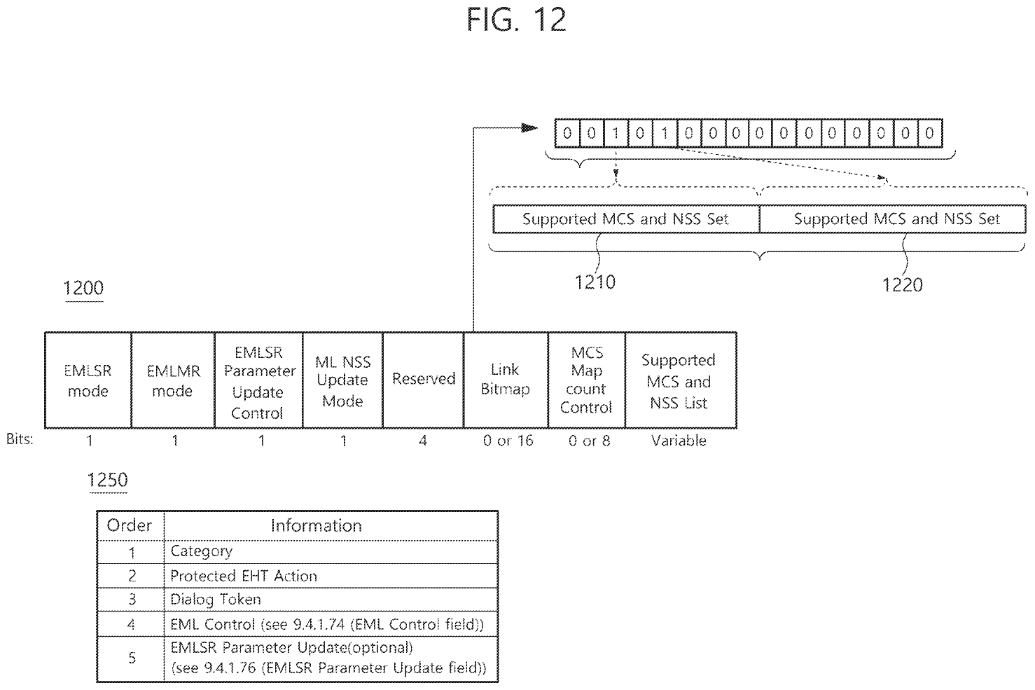

FIG. 12 shows an example EML control field 1200 in accordance with an embodiment. The example depicted in FIG. 12 is for explanation and illustration. The example does not limit the scope of this disclosure to any particular implementation.

In some embodiments, the EML control field 1200 may be included in the Action field of the EML OMN frame 1250. The EML OMN frame 1250 may be used to indicate that a non-AP MLD with which a transmitting STA is affiliated is changing its EML operation, such as EMLSR operation or EMLMR operation. The EML OMN frame 1250 may also be used by an AP affiliated with an AP MLD as a response to the received EML OMN frame from the solicitating STA affiliated with the non-AP MLD.

Referring to FIG. 12, the EML control field 1200 include an EMLSR mode field, an EMLMR mode field, an EMLSR Parameter Update Control field, a ML NSS Update Mode field, a Reserved field, a Link Bitmap field, an MCS Map count control field, and Supported MCS and NSS List field.

The EMLSR Mode field and the EMLMR Mode field may indicate if the MLD supports EMLSR operation and EMLMR operation, respectively.

The EMLSR Parameter Update Control field may indicate whether the EMLSR Parameter Update field is present in the EML OMN frame.

The ML NSS Update Mode field may indicate that the EML OMN frame is used to indicate changes in MCS and NSS Maps for one or more affiliated STAs of the transmitting MLD.

The Link Bitmap field may indicate one or more links for which the supported MCS and NSS Set update is provided. The Link Bitmap field may be the same as or similar to the one of the EMLSR/EMLMR Lin Bitmap field.

The MCS Map count control field may indicate the number of bandwidths, for example, {<=80, 160, 320} for which the MCS and NSS Maps are included in each Supported MCS and NSS set subfield within the Supported MCS and NSS List field.

The Supported MCS and NSS List field may include one or more the Supported MCS and NSS Sets for corresponding links indicated in the Link ID Bitmap field in ascending order.

Referring to FIG. 12, the Link Bitmap field indicates a third link and the fifth link of the transmitting MLD. The Supported MCS and NSS Set subfield 1210 indicates updates on supported MCS and NSS for the third link, while the Supported MCS and NSS Set subfield 1220 indicates updates on supported MCS and NSS for the fifth link.

The reconfiguration based on the update indicated by the EML control field 1200 may be initiated after receiving an EML OMN response frame or a transition timeout value indicated from an EML capabilities clement from an AP MLD or a non-AP MLD. In some implementations, after transmitting the EML OMN frame with the ML NSS Update mode set to 1, the transmitting non-AP MLD may perform the reconfiguration either immediately upon receiving an EML OMN response frame or after a predetermined timeout duration has passed since the transmission of the EML OMN frame. For example, the predetermined time out duration may be the transition timeout duration indicated by the AP MLD in the Transition Timeout subfield value of a basic multi-link clement.

In some implementations, it may take some time for a STA of the MLD to complete the reconfiguration process, during which the STA may not be able to receive frames, resulting in frame loss. The STA may mitigate or prevent the frame loss by utilizing power management, such as transitioning to a doze state.

In some implementations, upon receiving an EML OMN frame with ML NSS Update Mode field set to 1 from a non-AP MLD, the AP MLD may refrain from transmitting frames to the non-AP MLD on the links indicated in the Link Bitmap field of the EML OMN frame for the predetermined timeout duration. In this case, the STA of the non-AP MLD may perform the reconfiguration without utilizing the power management.

In some implementation, instead of including all of the EMSR mode field, the EMLMR mode field, the EMLSR parameter update Control field and the ML NSS Update Mode field, an EML Mode field with a length of 3 or 4 bits may be defined and various encodings can be used to indicate the corresponding information of those fields of EML OMN frame transmitted from the MLD.

In some implementations, when an MLD transmits an EML OMN frame with the ML NSS Update Mode field set to 1, the maximum RX NSS or the maximum TX NSTS indicated by a previous operating mode notification may become invalid for the links indicated by the Link Bitmap field. However, in other implementations, the previous operating mode notification for links indicated by the Link Bitmap field may remain valid. The operating mode can be changed cither on a per-link basis or by using multi-link operation mode notification frame.

In some implementations, the AP MLD may also use the EML OMN frame with the ML NSS Update Mode field set to 1 to indicate changes in the supported NSS for any affiliated STAs (i.e., AP STAs). In this scenario, the AP MLD may include the EML OMN frame in a group-address frame with the receive address set to the broadcast address to ensure that all associated non-AP MLDs can be aware of the indication. Alternatively, a STA affiliated with the AP MLD may include the EML OMN frame within a beacon frame or a probe response frame with sufficient time before the reconfiguration to ensure that all associated non-AP MLDs receive the notification. In some implementations, when the ML NSS Update Mode field is set to 1, the EML OMN frame may have a Timer field with 2 octets to include the number of TBTT to indicate when the updated NSS value becomes applicable. In an embodiment, the inclusion of the EML OMN frame in the beacon frame and the probe response frame may be considered a critical update and may result in an increase in the BSS Parameter Change count field.

In some implementations, it may take some time for an AP of the AP MLD to complete the reconfiguration process, during which the AP may be unable to receive frames, leading to frame loss. To prevent the frame loss, the AP may either schedule a quiet element that overlaps with the time indicated the Timer field or transmit CTS-to-self frame with a sufficient duration to cover the time required for completing the reconfiguration. In some embodiments, as a variant embodiment of FIG. 12, the supported MCS and NSS List field may be carried outside the EML control field of the EML OMN frame.

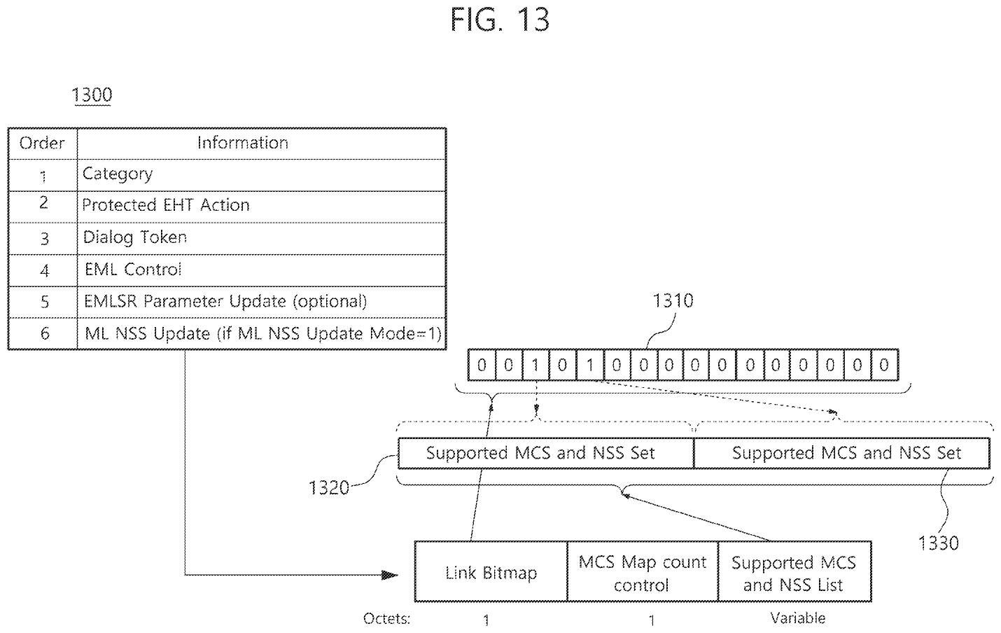

FIG. 13 shows an example protected EML OMN frame action field format 1300 in accordance with an embodiment. The example depicted in FIG. 13 is for explanation and illustration.

Referring to FIG. 13, the protected EML OMN frame action field 1300 may include a Category field, a Protected EHT Action field, a Dialog Token field, an EML Control field, an EMLSR Parameter Update field, and an ML NSS Update field.

The Category field may indicate a category of the action frame. The Protected EHT Action field may differentiate the Protected EHT action frame formats. The Dialog Token field may be used for matching action responses with action request when there are multiple concurrent action requests. The EML Control field may have various fields depicted in FIG. 12, with exceptions explained below. The EMLSR Parameter Update field may be optionally present in the EML OMN frame if the EMLSR Parameter Update Control subfield of the EML Control field is equal to 1 and the EML Operating Mode Notification frame is sent by a non-AP STA affiliated with a non-AP MLD. Otherwise, it is not present.

The ML NSS Update field may include a Link ID Bitmap field, an MCS Map count control field, and a Supported MCS and NSS List field. Those fields may be the same as or similar to corresponding fields in FIG. 12.

Similar to the example of FIG. 12, the ML NSS Update Mode field in the EML control field may indicate that the EML OMN frame is used to indicate changes in MCS and NSS Maps for one or more affiliated STAs of transmitting MLD. When the ML NSS Update Mode field in the EML OMN frame is set to 1, the ML NSS Update field may be present in the EML OMN frame.

The Link Bitmap field may indicate one or more links for which the supported MCS and NSS Set update is provided. The MCS Map count control field may indicate the number of bandwidths, for example, {<=80, 160, 320} for which the MCS and NSS Maps are included in each Supported MCS and NSS set subfield within the Supported MCS and NSS List field. The

Supported MCS and NSS List field may include the Supported MCS and NSS Sets for the links indicated in the Link Bitmap field in the ascending order.

Referring to FIG. 13, the link ID bitmap 1310 is provided in the Link Bitmap field. The link ID bitmap 1310 indicates ML NSS updates on the third link and the fifth link of the transmitting MLD. The Supported MCS and NSS Set subfield 1320 indicates updates on supported MCS and NSS for the third link, and the Supported MCS and NSS Set subfield 1330 indicates updates on supported MCS and NSS for the fifth link.

In some embodiments, a non-AP MLD may indicate the NSS update for a single link by transmitting an EML OMN frame. The indication may apply to only that one link or the current link on which the EML OMN frame is transmitted. In this scenario, separate indications for NSS updates should be provided for each link.

In some embodiments, after transmitting an EML OMN frame to indicate the reduction in the NSS for a link, a non-AP MLD may initiate the reconfiguration either immediately after receiving an EML OMN response frame or after a predetermined timeout duration following the transmission of the EML OMN frame. The predetermined timeout duration may be a transition timeout duration indicated by an AP MLD in the Transition Timeout subfield of a basic multi-link element.

In some embodiments, an EML OMN frame indicating an increase in the NSS for a link may be transmitted after the reconfiguration is completed. In some implementations, the indication for the link on which the NSS decreases is first provided, subsequently the indication for the link on which the NSS increases is provided following the reconfiguration.

In some embodiments, it may take some time for a STA of the MLD to complete the reconfiguration process, during which the STA may not be able to receive frames, resulting in frame loss. The STA may mitigate or prevent the frame loss by utilizing power management, such as transitioning to a doze state.

In some embodiments, upon receiving an EML OMN frame with ML NSS Update Mode field set to 1 from a non-AP MLD, the AP MLD may refrain from transmitting frames to the non-AP MLD on the links indicated in the Link Bitmap field of the EML OMN frame for the predetermined timeout duration. In this case, the STA of the non-AP MLD may perform the reconfiguration without utilizing the power management.

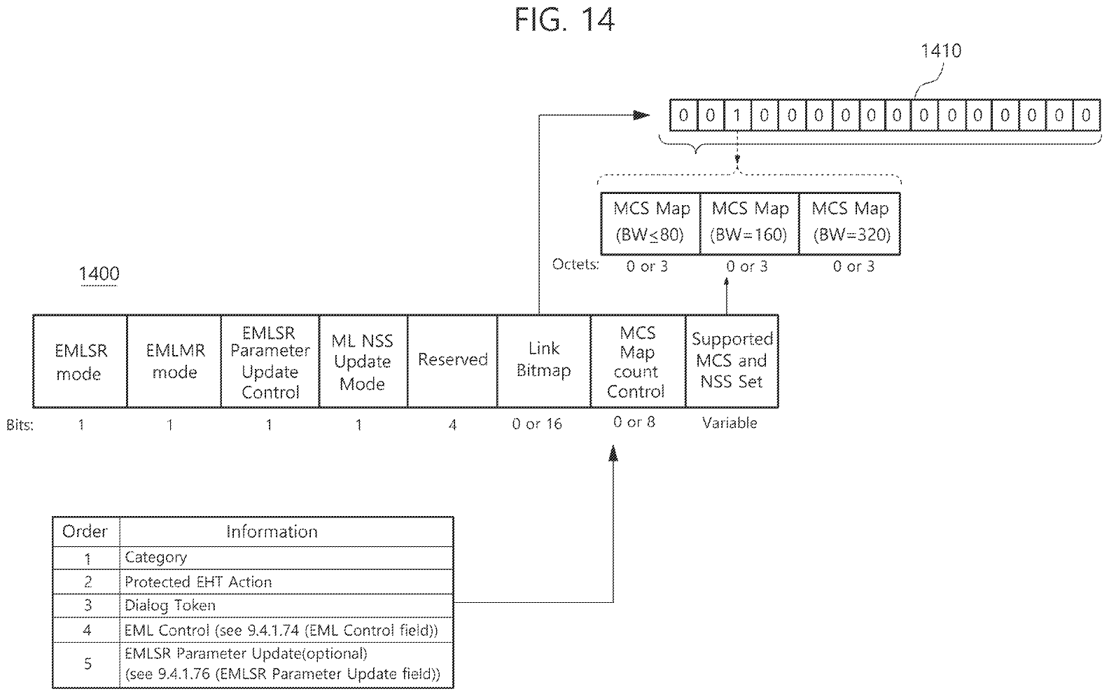

FIG. 14 shows an example EML control field 1400 in accordance with an embodiment. The example depicted in FIG. 14 is for explanation and illustration. The EML control field 1400 may be included in the Action field of an EML OMN frame.

Referring to FIG. 14, the EML control field 1400 may include an EMLSR mode field, an EMLMR mode field, an EMLSR Parameter Update Control field, a ML NSS Update Mode field, a Reserved field, a Link Bitmap field, an MCS Map count control field, and Supported MCS and NSS Set field. Various fields and subfields are the same as or similar to corresponding fields and subfields depicted in FIG. 12, with examples of difference described below.

The ML NSS Update Mod field may indicate that the EML OMN frame is used to indicate changes in MCS and NSS Maps for an affiliated STA of the transmitting MLD. For example, when the ML NSS Update Mode field is set to 1, the EML OMN frame is used to indicate changes in MCS and NSS Maps for the STA.

The Link Bitmap field may indicate the links for which the supported MCS and NSS Set update is provided. In some implementations, the Link Bitmap field may be the same as or similar to the one of the EMLSR/EMLMR Lin Bitmap field. The Link Bitmap field may be set to 1 for only one link. The MCS Map count control field may indicate the number of bandwidths, for example, {<=80, 160, 320}, for which the MCS and NSS Maps subfield of the Supported MCS and NSS Set field.

The Supported MCS and NSS Set field may include MCS Maps for the links indicated in the Link Bitmap field. Referring to FIG. 14, the link ID bitmap 1410 is provided in the Link Bitmap field. The link ID bitmap 1410 indicates ML NSS updates on the third link of the transmitting MLD. The Supported MCS and NSS Set field includes three MCS Map fields for BWs {<=80, 160, 320}. The changes on MCS and NSS may be applicable after receiving an EML OMN response frame or after a transition timeout delay.

In some embodiment, an MLD may indicate the update on MCS Maps for one or more affiliated STAs by including the ML reconfiguration element in a frame.

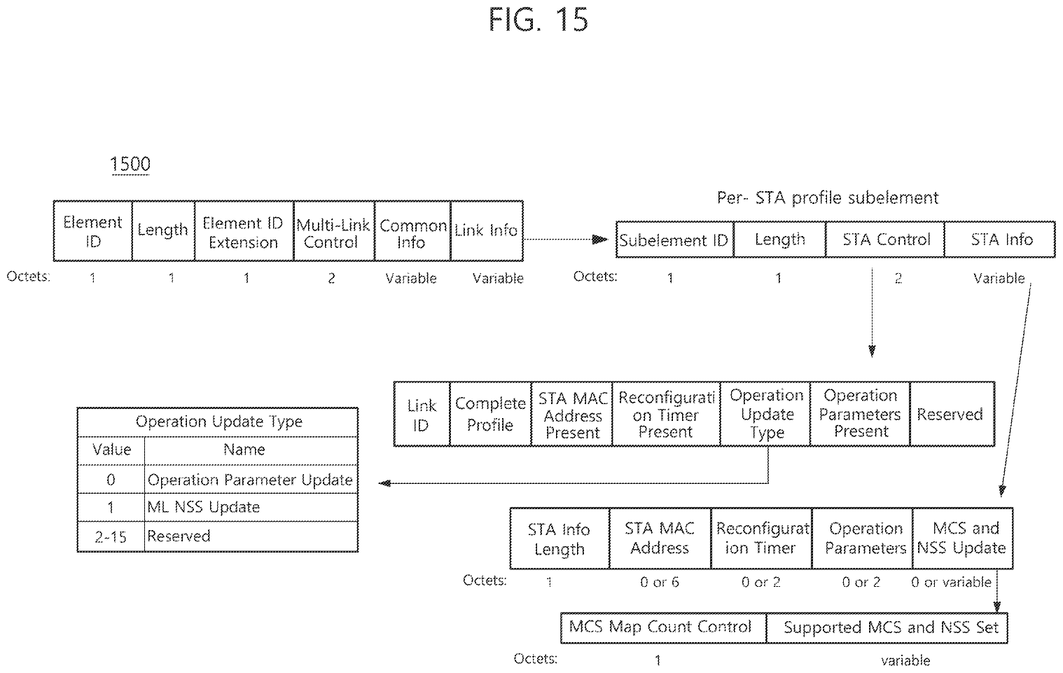

FIG. 15 shows an example ML reconfiguration element 1500 in accordance with an embodiment. The example depicted in FIG. 15 is also for illustrative purposes only and does not limit the scope of this disclosure to any particular implementation.

In FIG. 15, the ML reconfiguration element 1500 includes an Element ID field, a Length field, an Element ID Extension field, a Multi-link Control field, a Common field, and a Link Info field.

The Element field and the Element ID Extension field may include information to identify the ML reconfiguration element. The Length field may indicate the length of the ML reconfiguration element. The Multi-Link Control field may indicate the type of the ML reconfiguration element and the presence of various subfields in the Common Info field. The Common Info field may carry information that is common to all links, with some exceptions. The Link Info field may carry information specific to one or more links. The Link Info field includes one or more Per-STA subelements. The Per-STA subelemnt includes a Subelement ID field, a Length field, a STA Control field, and STA Info field.

The Subelement ID field may be defined for Per-STA profile element. The Length field may indicate the length of the Per-STA subelement. The STA Control field includes a Link ID subfield, a Complete Profile subfield, a STA MAC Address Present subfield, an Reconfiguration Timer Present subfield, an Operation Update Type subfield, an Operation Parameters Present subfield, and Reserved subfield.

The Link ID subfield may specify a value that uniquely identifies the link which the reported STA is operating on. The Complete Profile subfield may indicate if the Per-STA profile subelement carries a complete profile. The STA MAC Address Present subfield may indicate the presence of the STA MAC Address subfield in the STA Info field. The Reconfiguration Timer Present subfield may indicate the presence of Reconfiguration Timer in the STA Info field. The Operation Update Type subfield may indicate an operation update type, including Operating Parameter Update type or ML NSS Update type as shown in FIG. 15. The Operation Parameter Present subfield may indicate the presence of the Operation Parameter subfield in the STA Info field. In some implementations, the Reconfiguration Timer Present subfield may reuse an AP Removal Present subfield when the Operation Update Type subfield indicates ‘ML NSS Update’ type.

The STA Info field includes a STA Info Length subfield, a STA MAC Address subfield, a Reconfiguration Timer subfield, an Operation Parameters subfield, and a MAC and NSS Update subfield.

The STA Info Length subfield may indicate the number of octets in the STA Info field. The STA MAC Address subfield may include the MAC address of the STA which operates on or can operate on the link identified by the Link ID subfield. The Reconfiguration Timer subfield may indicate the number of TBTTs of the AP corresponding to the Per-STA profile subelement until the reconfiguration is completed. The Operation Parameters subfield may include operation parameters to be updated, such as maximum MPDU (MAC protocol data unit) length and maximum A-MSDU (aggregate MAC protocol data unit) length. The MCS and NSS Update subfield may include a MCS Map Count Control field and a Supported MAC and NSS Set field that includes MCS Maps for the link indicated in the Link ID subfield. The MCS Map Count field may indicate the number of BWs, for example {<=80, 160, 320} MHz, for which the MCS and NSS Maps are included in the Supported MCS and NSS Set field.

When the Operation Update Type subfield is set to ‘1,’ indicating the ML NSS Update, the STA MAC Address subfield and the Operation Parameters subfield in the STA Info field may be absent, while the MCS and NSS Update subfield are present and the Reconfiguration Timer subfield optionally present. The Reconfiguration Timer subfield may be implemented the same as or similar to the AP Removal timer subfield. The updated MCS and NSS set may be applicable after the end of the duration indicated in the Reconfiguration Timer subfield. In some implementations, the Supported MCS and NSS Set subfield may indicate the new EHT MCS and NSS set that is applicable for the STA that is identified by the Link ID subfield.

In some implementations, when an AP MLD intends to initiate the reconfiguration, an AP of the AP MLD may include the ML reconfiguration element in a beacon frame or a probe response frame with a sufficient time before the reconfiguration to ensure that all associated non-AP MLDs can receive the reconfiguration indication. In some implementations, a Reconfiguration Timer subfield with a length of 2 octets may indicate the number of TBTTs until the updated NSS value becomes applicable. In one embodiment, the inclusion of the ML reconfiguration element in a beacon frame and a probe response frame may be considered as a critical update and may increase the BSS Parameter Change count field.

In some implementations, when a non-AP MLD intends to initiate the reconfiguration, a STA of the non-AP MLD may transmit a frame that includes the ML reconfiguration element. The frame may be, for example, the ML operation update request frame. Upon receiving the frame. The AP MLD may transmit a response frame indicating acceptance of the request. In this scenario, the non-AP MLD MAY initiate the reconfiguration upon receiving the response frame.

In some implementations, an ‘ML NSS Update Support’ bit may be included in the MLD Capabilities and Operations field or the Extended Capabilities and Operations field of a basic ML clement transmitted by the AP MLD or the non-AP MLD. The ML NSS Update Support bit may indicate the support for receiving an ML reconfiguration element with the Operation Update Type field set to the ML NSS Update in the STA Info field. Accordingly, a transmitting MLD may perform a reconfiguration of the MCS and NSS across the links by transmitting an ML reconfiguration clement to receiving MLD if the receiving MLD indicates the support by setting the ML NSS Support bit to 1 in the Basic ML element.

In some embodiments, an MLD may transmit part or all of the EHT Capabilities clement, which may be referred to as ‘EHT Capabilities Update element,’ in a frame to indicate any changes to the EHT capabilities, including the Supported EHT MCS and NSS Sets. A control bitmap field may be present in the frame to indicate the fields of the EHT Capabilities clement which are present in the EHT Capabilities Update element. The frame may also, in one variant, contain a timer field to indicate when the new EHT Capabilities becomes applicable. The frame can either be a per-link indication frame or a multi-link indication frame that indicates the capabilities for one or more links of the transmitting MLD. In the latter case, a link ID bitmap can be present to indicate the links for which the EHT Capabilities Updated elements are included.

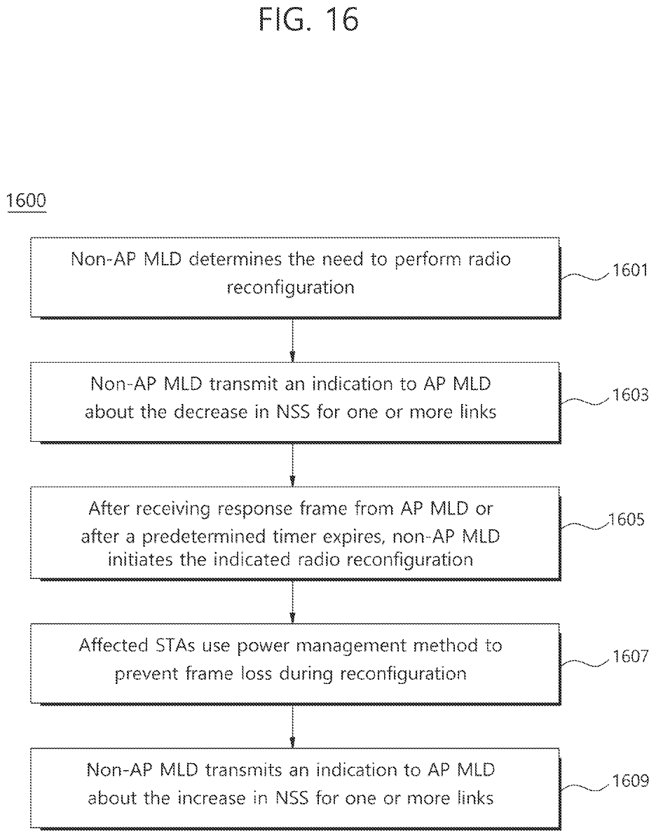

FIG. 16 shows a flow chart of an example process for reconfiguration performed by a non-AP MLD in accordance with an embodiment. For explanatory and illustration purposes, the example process 1600 may be performed by a non-AP MLD 320 of FIG. 3. Although one or more operations are described or shown in particular sequential order, in other embodiments the operations may be rearranged in a different order, which may include performance of multiple operations in at least partially overlapping time periods.

The process 1600 may begin in operation 1601. In operation 1601, a reconfigurable non-AP MLD may determine the need to perform radio reconfiguration while communicating with an associated AP MLD. Then, the process 1600 proceeds to operation 1603.

In operation 1603, the non-AP MLD may transmit an indication to the AP MLD about the decreases on TX NSS and RX NSS for one or more links. The indication may be transmitted jointly or sequentially to the AP MLD. In response to transmission of the indication, the non-AP MLD may receive a response frame from the AP MLD. Then, the process 1600 proceeds to the operation 1605.

In operation 1605, after receiving the response frame from the AP MLD or after a predetermined timer expires, the non-AP MLD may initiate the indicated radio reconfiguration by changing TX NSS and RX NSS for the one or more links. Then, the process 1600 proceeds to the operation 1607.

In operation 1607, STAs of the non-AP MLD whose NSS is reduced by the radio reconfiguration use power management to prevent frame loss during the reconfiguration. For example, when an STA's NSS becomes zero (0), the STA may enter a doze state. Then, the process 1600 proceeds to the operation 1609.

In operation 1609, the non-AP MLD transmits an indication to the AP MLD about the increase in NSS for one or more links.

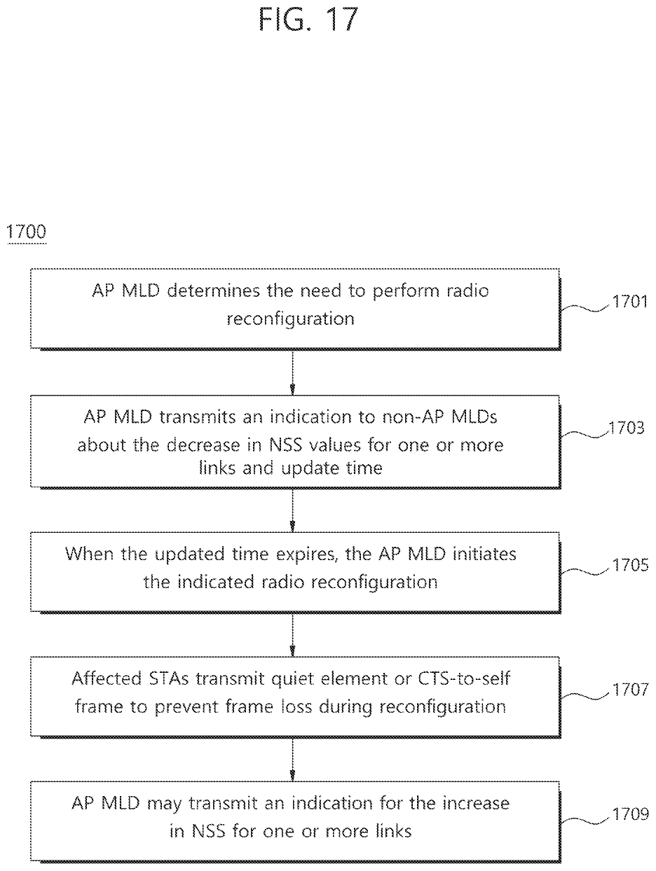

FIG. 17 shows a flow chart of an example process for reconfiguration performed by a non-AP MLD in accordance with an embodiment. For explanatory and illustration purposes, the example process 1700 may be performed by an AP MLD 310 of FIG. 3. Although one or more operations are described or shown in particular sequential order, in other embodiments the operations may be rearranged in a different order, which may include performance of multiple operations in at least partially overlapping time periods.

The process 1700 may begin in operation 1701. In operation 1701, an AP MLD may determine the need to perform radio reconfiguration while communicating with one or more associated non-AP MLDs. Then, the process 1700 proceeds to operation 1703.

In operation 1703, the AP MLD may transmit an indication to one or more associated non-AP MLDs about the decrease in TX NSS and RX NSS for one or more links along with an update time.

In operation 1705, when the update time expires, the AP MLD initiates the indicated radio reconfiguration by changing TX NSS and RX NSS for the one or more links.

In operation 1707, APs of the AP MLD whose NSS is reduced by the radio reconfiguration transmit a quite element or CTS-to-self frame to associated non-AP STAs to prevent frame loss during the reconfiguration. For example, when an AP's NSS becomes zero (0), the AP may transmit a quite element or CTS-to-self frame to associated non-AP STA. Then, the process 1700 proceeds to the operation 1709.

In operation 1709, the AP MLD transmits an indication to associated non-AP MLDs about the increase in NSS for one or more links.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A non-access point (AP) multi-link device (MLD) associated with an AP MLD in a wireless network, the non-AP MLD comprising:
at least two stations (STAs), each STA being affiliated with the non-AP MLD; and
a processor coupled to the at least two STAs, the processor configured to cause:
communicating with the AP MLD on a plurality of links established between the non-AP MLD and the AP MLD;
generating a notification indicating a change in a set of numbers of supported spatial streams for each of one or more links established between the non-AP MLD and the AP MLD;
transmitting a frame including the notification to the AP MLD; and
initiating radio reconfiguration on the one or more links using the change in the set of numbers of supported spatial streams for each of the one or more links.

2. The non-AP MLD of claim 1, wherein the set of numbers of supported spatial streams includes a set of numbers of supported spatial streams for one or more modulation and coding schemes for each of the one or more links.

3. The non-AP MLD of claim 1, wherein the processor is configured to cause:
receiving a response frame in response to the notification from the AP MLD; and
initiating the radio reconfiguration on the one or more links using the change in the set of numbers of supported spatial streams for each of the one or more links.

4. The non-AP MLD of claim 1, wherein the processor is configured to cause:
initiating the radio reconfiguration on the one or more links using the change in the set of numbers of supported spatial streams for each of the one or more links after a predetermined time following the transmission of the frame.

5. The non-AP MLD of claim 1, wherein the notification includes a first field indicating the one or more links and one or more second fields, each second field indicating a change in a number of supported spatial streams for a respective link indicated in the first field.

6. The non-AP MLD of claim 4, wherein the notification includes a third field indicating when the changed number of supported spatial streams is applicable on the respective link.

7. The non-AP MLD of claim 1, wherein the notification indicates a decrease in a number of supported spatial streams for a first link established between a first STA affiliated with the non-AP MLD and a first AP affiliated with the AP MLD.

8. The non-AP MLD of claim 7, wherein the processor is further configured to cause:
transmitting, to the AP MLD, another frame includes a notification indicating an increase in a number of supported spatial streams for a second link established between a second STA affiliated with the non-AP MLD and a second AP affiliated with the AP MLD after the radio reconfiguration is completed.

9. The non-AP MLD of claim 7, wherein the processor is further configured to cause:
transitioning the first STA to a doze state when the change number of supported spatial streams for the first STA is zero.

10. An access point (AP) multi-link device (MLD) in a wireless network, the AP MLD comprising:
at least two APs, each AP being affiliated with the AP MLD; and
a processor coupled to the at least two APs, the processor configured to cause:
communicating with one or more non-AP MLDs on a plurality of links established between the AP MLD and the one or more non-AP MLDs;
generating a notification indicating a change in a set of numbers of supported spatial streams for each of one or more links established between the AP MLD and the one or more non-AP MLDs;
transmitting a frame including the notification to the one or more non-AP MLDs; and
initiating radio reconfiguration on the one or more links using the change in the set of numbers of supported spatial streams for each of the one or more links.

11. The AP MLD of claim 10, wherein the set of numbers of supported spatial streams includes a set of numbers of supported spatial streams for one or more modulation and coding schemes for each of the one or more links.

12. The AP MLD of claim 10, wherein the notification includes a timer information indicating when the radio configuration is initiated.

13. The AP MLD of claim 10, wherein the processor is configured to cause:
initiating the radio reconfiguration on the one or more links using the change in the set of numbers of supported spatial streams for each of the one or more links after a predetermined time following the transmission of the frame.

14. The AP MLD of claim 10, wherein the frame is a broadcast frame.

15. The AP MLD of claim 10, wherein the frame is an individually addressed frame.

16. The AP MLD of claim 10, wherein the notification includes a first field indicating the one or more links and one or more second fields, each second field indicating a change in a number of supported spatial streams for a respective link indicated in the first field.

17. The AP MLD of claim 10, wherein the notification indicates a decrease in a number of supported spatial streams for a first link established between a first AP affiliated with the AP MLD and one or more first STAs affiliated with the one or more non-AP MLDs.

18. The AP MLD of claim 17, wherein the processor is further configured to cause:
transmitting, to the AP MLD, another frame includes a notification indicating an increase in a number of supported spatial streams for a second link established between a second AP affiliated with the AP MLD and one or more second STAs affiliated with the one or more non-AP MLDs after the radio reconfiguration is completed.

19. The AP MLD of claim 17, wherein the processor is further configured to cause:
coordinating that the first AP transmits a quite element for a duration to the one or more first STAs when the change number of supported spatial streams for the first AP is zero.

20. The AP MLD of claim 17, wherein the processor is further configured to cause:
coordinating that the first AP transmits a clear to send (CTS) frame when the change number of supported spatial streams for the first AP is zero, wherein a receiver address in the CTS frame is equal to an address of the first AP.
